(19) United States
(12) Patent Application Publication
(10) Pub. No.: US 2016/0012946 A1
(43) Pub. Date: Jan. 14, 2016

(54) METHOD OF MANUFACTURING ALLOY FOR R-T-B-BASED RARE EARTH SINTERED MAGNET AND METHOD OF MANUFACTURING R-T-B-BASED RARE EARTH SINTERED MAGNET

(71) Applicant: SHOWA DENKO K.K., Tokyo (JP)

(72) Inventors: Masaki HORIKITA, Chichibu-shi (JP); Takashi YAMAZAKI, Chichibu-shi (JP); Kenichiro NAKAJIMA, Chichibu-shi (JP)

(73) Assignee: SHOWA DENKO K.K., Tokyo (JP)

(21) Appl. No.: 14/789,495

(22) Filed: Jul. 1, 2015

(30) Foreign Application Priority Data
Jul. 8, 2014 (JP) 2014-140374

(51) Int. Cl. H01F 1/057; B22F 9/08; H01F 41/02; B22F 9/02

(52) U.S. Cl. CPC H01F 1/0573; B22F 9/023; B22F 9/08; H01F 41/0266; H01F 1/0577

(57) ABSTRACT

Provided is a method of manufacturing an alloy for an R-T-B-based rare earth sintered magnet, with which an R-T-B-based magnet having high coercive force can be obtained even when the B concentration is low and the Dy concentration is zero or extremely low.

This method includes: a casting step of manufacturing a cast alloy by casting a molten alloy, a hydrogenating step of absorbing hydrogen in the cast alloy; and a dehydrogenating step of removing hydrogen from the cast alloy absorbing hydrogen in an inert gas atmosphere at a temperature lower than 550° C., wherein the molten alloy consists of B, a rare earth element R, a transition metal T essentially containing Fe, a metal element M, and unavoidable impurities, in which the R content is 13 at % to 15.5 at %, the B content is 5.0 at % to 6.0 at %, the M content is 0.1 at % to 2.4 at %, the T content is a balance, a ratio of a Dy content to the total content of the rare earth element is 0 at % to 65 at %, and the molten alloy satisfies the below formula (1).

0.32≦B/TRE≦0.40 (1).

### BACKGROUND OF THE INVENTION

1. Field of the Invention

The present invention relates to a method of manufacturing an alloy for an R-T-B-based rare earth sintered magnet and a method of manufacturing an R-T-B-based rare earth sintered magnet.

Priority is claimed on Japanese Patent Application No. 2014-140374, filed on Jul. 8, 2014, the content of which is incorporated herein by reference.

2. Description of Related Art

In the related art, an R-T-B-based rare earth sintered magnet (hereinafter, may also be abbreviated as “R-T-B-based magnet”) is used for a motor such as a voice coil motor of a hard disk drive or an engine motor of a hybrid vehicle or an electric vehicle.

The R-T-B-based magnet is obtained by molding and sintering R-T-B-based alloy powder containing Nd, Fe, and B as main components. Typically, in the R-T-B-based alloy, R is Nd and a part thereof is substituted with another rare earth element such as Pr, Dy, or Tb. T is Fe a part of which is substituted with another transition metal such as Co or Ni. B is boron and a part thereof may be substituted with C or N.

The structure of an ordinary R-T-B-based magnet includes: a main phase that contains R₂T₁₄B; and an R-rich phase that is present in grain boundaries of the main phase and has a higher Nd concentration than that in the main phase. The R-rich phase is also called a grain boundary phase.

In addition, typically, the composition of an R-T-B-based alloy is adjusted such that a ratio of Nd, Fe, and B is as close to R₂T₁₄B as possible in order to increase a ratio of the main phase in the structure of the R-T-B-based magnet (for example, refer to “Permanent Magnet —Material Science and Application” by Masato Sagawa, First Edition Second Impression published on Nov. 30, 2008, pp. 256 to 261)

In addition, the R-T-B-based (R-T-B) alloy may contain an R₂T₁₇ phase. The R₂T₁₇ phase is known to cause a decrease in the coercive force or squareness of the R-T-B-based magnet (for example, refer to Japanese Unexamined Patent Application, First Publication No. 2007-119882). Therefore, in the related art, when being present in the R-T-B-based alloy, the R₂T₁₇ phase is removed during a sintering process for manufacturing an R-T-B-based magnet.

In addition, an R-T-B-based magnet used for an automotive motor is exposed to a high temperature in the motor and thus is required to have high coercive force (Hcj).

As a technique of improving the coercive force of the R-T-B-based magnet, a technique of substituting Nd with Dy in R of the R-T-B-based alloy is disclosed. However, the resources of Dy are unevenly distributed, and the production thereof is limited. Accordingly, the supply of Dy is unstable. Therefore, a technique of improving the coercive force of an R-T-B-based magnet without increasing the Dy content in an R-T-B-based alloy has been studied.

In order to improve the coercive force (Hcj) of an R-T-B-based magnet, a technique of adding a metal element such as Al, Si, Ga, or Sn is disclosed (for example, refer to Japanese Unexamined Patent Application, First Publication No. 2009-231391). In addition, as described in Japanese Unexamined Patent Application, First Publication No. 2009-231391, it is known that Al or Si is incorporated into an R-T-B-based magnet as an unavoidable impurity. In addition, it is known that, when the Si content as an impurity contained in an R-T-B-based alloy exceeds 5%, the coercive force of the R-T-B-based magnet decreases (for example, refer to Japanese Unexamined Patent Application, First Publication No. H05-112852).

With the techniques of the related art, even when a metal element such as Al, Si, Ga, or Sn is added to an R-T-B-based alloy, an R-T-B-based magnet having sufficient high coercive force (Hcj) may not be obtained. As a result, even after the addition of the metal element, it is necessary to increase the Dy concentration.

As a result of studying the composition of an R-T-B-based alloy, the present inventors have found that the coercive force is at the maximum at a specific B concentration. Based on the obtained result, the present inventors have succeeded in development of an R-T-B-based alloy which is completely different from that of the related art, with which an R-T-B-based magnet having high coercive force can be obtained even when the Dy content in the R-T-B-based alloy is zero or extremely low (refer to Japanese Unexamined Patent Application, First Publication No. 2013-216965). The B concentration in this alloy is lower than that of an R-T-B-based alloy of the related art.

An R-T-B-based magnet manufactured by using the R-T-B alloy includes: a main phase that contains R₂Fe₁₄B as a main component; and a grain boundary phase that has a higher R content than the main phase, in which the grain boundary includes a grain boundary phase (transition metal-rich phase) having a lower rare earth element concentration (except for a grain boundary phase (R-rich phase) which is conventionally known to have a high rare earth element concentration) and a higher transition metal element concentration than a grain boundary phase of the related art. An R-T-B-based magnet of the related art includes: a main phase as a magnetic phase that exhibits coercive force; and a grain boundary phase as a non-magnetic phase that is disposed in grain boundaries of the main phase. It is considered that, in the new R-T-B-based magnet developed by the present inventors, the transition metal-rich phase includes a large amount of transition metal and thus exhibits coercive force. The magnet in which the phase exhibiting coercive force (“transition metal-rich phase”) is present in the grain boundary phase is revolutionary enough to defy past common knowledge.

However, the R-T-B-based magnet is manufactured by causing a cast alloy, which is obtained by casting a molten alloy having a predetermined composition, to undergo crushing, molding, and sintering.

The cast alloy is crushed in order of hydrogen decrepitation and fine crushing.

Here, the hydrogen decrepitation is divided into two steps: a hydrogenating step as a pre-step; and a dehydrogenating step as a post-step.

In the hydrogenating step, hydrogen is mainly absorbed into an R-rich phase of an alloy strip and swells to form a brittle hydride. Therefore, during the hydrogen decrepitation, fine cracks propagate along or are initiated from the R-rich phase in the alloy strip. In the subsequent fine crushing step, the alloy strip is destroyed due to a large amount of the fine cracks that are produced during the hydrogen decrepitation.

The hydride produced during the hydrogenating step is unstable in air and is likely to be oxidized. Therefore, typically, the dehydrogenating step is performed.

The dehydrogenating step is performed by substituting a vacuum or a furnace atmosphere with Ar gas (inert gas) (for example, refer to Japanese Patent No. 4215240). Since an R₂T₁₄B phase is decomposed at 700° C. or higher, it is necessary to perform the dehydrogenating step at a temperature lower than 700° C. For example, Japanese Patent No. 4215240 describes that the dehydrogenating step is performed in an Ar gas atmosphere at 600° C.

### SUMMARY OF THE INVENTION

As described above, the R-T-B magnet developed by the present inventors has the configuration that defies the common knowledge of a sintered magnet of the related art and has a large amount of potential. Properties of an R-T-B magnet are affected by the production process thereof. Therefore, it is considered that, in order to maximize the potential of an R-T-B-based magnet, the production process and production conditions thereof are required to be different from those of an R-T-B-based magnet of the related art.

The present invention has been made in consideration of the above-described circumstances, and an object thereof is to provide a method of manufacturing an alloy for an R-T-B-based rare earth sintered magnet and a method of manufacturing an R-T-B-based rare earth sintered magnet, with which an R-T-B-based magnet having high coercive force and superior squareness can be obtained even when the B concentration is lower than that of the magnet of the related art, which is developed by the present inventors, and the Dy concentration is zero or extremely low.

In order to solve the above-described problems, the present invention has adopted the following means.

(1) According to an aspect of the present invention there is provided a method of manufacturing an alloy for an R-T-B-based rare earth sintered magnet, the method including: a casting step of manufacturing a cast alloy by casting a molten alloy, a hydrogenating step of absorbing hydrogen in the cast alloy; and a dehydrogenating step of removing hydrogen from the cast alloy, that absorbs hydrogen, in an inert gas atmosphere at a temperature lower than 550° C., wherein the molten alloy consists of B, a rare earth element R, a transition metal T essentially containing Fe, a metal element M that contains at least one metal selected from the group consisting of Al, Ga, and Cu, and unavoidable impurities, the R content is 13 at % to 15.5 at %, the B content is 5.0 at % to 6.0 at %, the M content is 0.1 at % to 2.4 at %, the T content is a balance, the ratio of a Dy content to the total amount of the rare earth element is 0 at % to 65 at %, and the molten alloy satisfies the below formula (1).

0.32≦B/TRE≦0.40 (1)

wherein B represents a boron concentration (at %), and TRE represents the total concentration (at %) of all the rare earth elements in the formula (1).

(2) According to another aspect of the present invention, there is provided a method of manufacturing an alloy for an R-T-B-based rare earth sintered magnet, the method including: a casting step of manufacturing a cast alloy by casting a molten alloy, a hydrogenating step of absorbing hydrogen in the cast alloy; and a dehydrogenating step of removing hydrogen from the cast alloy, that absorbs hydrogen, in a vacuum at a temperature lower than 600° C., wherein the molten alloy consists of B, a rare earth element R, a transition metal T essentially containing Fe, a metal element M that contains at least one metal selected from the group consisting of Al, Ga, and Cu, and unavoidable impurities, in which the R content is 13 at % to 15.5 at %, the B content is 5.0 at % to 6.0 at %, the M content is 0.1 at % to 2.4 at %, the T content is a balance, the ratio of the Dy content to the total content of the rare earth element is 0 at % to 65 at %, and the molten alloy satisfies the below formula (1).

0.32≦B/TRE≦0.40 (1)

wherein B represents the boron concentration (at %), and TRE represents the total concentration (at %) of all the rare earth elements in the formula (1).

(3) In the method of manufacturing an alloy for an R-T-B-based rare earth sintered magnet according to (1), the dehydrogenating step may be performed at 300° C. to 500° C.

(4) In the method of manufacturing an alloy for an R-T-B-based rare earth sintered magnet according to (2), the dehydrogenating step may be performed at 300° C. to 500° C.

(5) According to still another aspect of the present invention, there is provided a method of manufacturing an R-T-B-based rare earth sintered magnet, in which an alloy for an R-T-B-based rare earth sintered magnet, which is manufactured by using the method of manufacturing an alloy for an R-T-B-based rare earth sintered magnet according to (1), is used.

(6) According to still another aspect of the present invention, there is provided a method of manufacturing an R-T-B-based rare earth sintered magnet, in which an alloy for an R-T-B-based rare earth sintered magnet, which is manufactured by using the method of manufacturing an alloy for an R-T-B-based rare earth sintered magnet according to (2), is used.

(7) A method of manufacturing an R-T-B-based rare earth sintered magnet, in which an alloy for an R-T-B-based rare earth sintered magnet, which is manufactured by using the method of manufacturing an alloy for an R-T-B-based rare earth sintered magnet according to (3), is used.

(8) A method of manufacturing an R-T-B-based rare earth sintered magnet, in which an alloy for an R-T-B-based rare earth sintered magnet, which is manufactured by using the method of manufacturing an alloy for an R-T-B-based rare earth sintered magnet according to (4), is used.

(9) A method of manufacturing an R-T-B-based rare earth sintered magnet, comprising steps of manufacturing an alloy for an R-T-B-based rare earth sintered magnet by using the method according to (1), and manufacturing an R-T-B-based rare earth sintered magnet by using the obtained alloy for an R-T-B-based rare earth sintered magnet.

(10) A method of manufacturing an R-T-B-based rare earth sintered magnet, comprising steps of manufacturing an alloy for an R-T-B-based rare earth sintered magnet by using the method according to (2), and manufacturing an R-T-B-based rare earth sintered magnet by using the obtained alloy for an R-T-B-based rare earth sintered magnet.

(11) The method of manufacturing an R-T-B-based rare earth sintered magnet according to (9), in which in the step of manufacturing an alloy for an R-T-B-based rare earth sintered magnet, the dehydrogenating step is performed at 300° C. to 500° C.

(12) The method of manufacturing an R-T-B-based rare earth sintered magnet according to (10), in which in the step of manufacturing an alloy for an R-T-B-based rare earth sintered magnet, the dehydrogenating step is performed at 300° C. to 500° C.

By using the method of manufacturing an alloy for an R-T-B-based rare earth sintered magnet according to the present invention, an alloy for an R-T-B-based rare earth sintered magnet can be provided, with which an R-T-B-based rare earth sintered magnet having high coercive force and superior squareness can be obtained while limiting the Dy content.

### BRIEF DESCRIPTION OF THE DRAWINGS

FIG. 1 is an R-T-B ternary phase diagram.

FIG. 2 is a schematic front view showing an example of an apparatus configured to produce a cast alloy.

FIG. 3 is a graph showing the results of examining the amounts of hydrogen removed from alloys of Example 3 and Comparative Example 2 when being heated.

FIG. 4 is a backscattered electron image showing an R-T-B-based magnet of Example 3.

FIG. 5 is a graph showing the results of examining the Ga concentrations of R-rich phases of Examples 3 and 5 and Comparative Examples 2 and 3.

### DETAILED DESCRIPTION OF THE INVENTION

Hereinafter, an embodiment of the present invention will be described in detail. The present invention is not limited to the embodiment described below, and appropriate modifications can be made within a range not departing from the scope of the present invention.

In this specification, “cast alloy” refers to an alloy obtained by casting a molten alloy using a strip cast method. In the present invention, “alloy for an R-T-B-based rare earth sintered magnet” of “method of manufacturing an alloy for an R-T-B-based rare earth sintered magnet” refers to “cast alloy” (including strip) that undergoes a hydrogen decrepitation step and does not undergo a sintering step for manufacturing a sintered magnet.

### [Alloy for R-T-B-Based Rare Earth Sintered Magnet]

By molding and sintering an alloy for an R-T-B-based rare earth sintered magnet (hereinafter, abbreviated as “R-T-B-based alloy”) which is produced using the method of manufacturing an alloy for an R-T-B-based rare earth sintered magnet according to the embodiment of the present invention, an R-T-B-based rare earth sintered magnet can be obtained. The R-T-B-based rare earth sintered magnet is formed of a sintered compact including: a main phase that contains R₂Fe₁₄B as a main component; and a grain boundary phase that has a higher R content than the main phase. The grain boundary phase contains an R-rich phase and a transition metal-rich phase that has a lower rare earth element concentration and a higher transition metal element concentration than the R-rich phase.

In the R-rich phase of the R-T-B-based rare earth sintered magnet, the total atomic concentration of R which is the rare earth element is 70 at % or higher. In the transition metal-rich phase, the total atomic concentration of the rare earth element R is 25 at % to 35 at %. In the transition metal-rich phase, the concentration of T which is the transition metal essentially containing Fe is preferably 50 at % to 70 at %.

The molten alloy used in the casting step of the method of manufacturing an alloy for an R-T-B-based rare earth sintered magnet according to the embodiment (hereinafter, may also be abbreviated as “R-T-B-based molten alloy”) is an R-T-B-based alloy including: R that is a rare earth element; T that is a transition metal essentially containing Fe; a metal element M that contains at least one metal selected from the group consisting of Al, Ga, and Cu; and B and unavoidable impurities, in which the R content is 13 at % to 15.5 at %, the B content is 4.5 at % to 6.2 at %, the M content is 0.1 at % to 2.4 at %, the T content is a balance, and the below formula (1) is satisfied. In addition, in the R-T-B-based molten alloy according to the embodiment, the ratio of the Dy content to the total amount of the rare earth element is 0 at % to 65 at %.

0.32≦B/TRE≦0.40 (1)

In the formula (1), B represents the boron concentration (at %), and TRE represents the total concentration (at %) of all the rare earth elements.

When the R content in the R-T-B-based molten alloy is lower than 13 at %, the coercive force of an R-T-B-based magnet obtained by using the R-T-B-based molten alloy is insufficient. In addition, when the R content exceeds 15.5 at %, the residual magnetization of an R-T-B-based magnet obtained using the R-T-B-based molten alloy is decreased, and thus the R-T-B-based magnet is not suitable as a magnet.

The Dy content in the R-T-B-based molten alloy with respect to all the rare earth elements is 0 at % to 65 at %. In the embodiment, the coercive force of the R-T-B-based molten alloy is improved by containing the transition metal-rich phase. Therefore, the R-T-B-based molten alloy may not contain Dy, and when containing Dy, a sufficiently high effect of improving the coercive force is obtained at a Dy content of 65 at % or lower.

Examples of the rare earth element other than Dy used in the R-T-B-based molten alloy include Sc, Y, La, Ce, Pr, Nd, Pm, Sm, Eu, Gd, Tb, Ho, Er, Tm, Yb, and Lu. Among these, Nd, Pr, or Tb is preferably used. In addition, it is preferable that R of the R-T-B-based alloy contains Nd as a main component.

In addition, B contained in the R-T-B-based molten alloy is boron a part of which may be substituted with C or N. The B content is equal to or more than 5.0 at % and equal to or less than 6.0 at % and satisfies the above-described formula (1). The B content is more preferably 5.5 at % or lower. When the B content in the R-T-B-based alloy is lower than 5.0 at %, the coercive force of an R-T-B-based magnet obtained by using the R-T-B-based alloy is insufficient. When the B content exceeds the above-described range of formula (1), the production amount of the transition metal-rich phase is insufficient, and the coercive force is not sufficiently improved.

The R-T-B-based alloy manufactured by using the method of manufacturing an R-T-B-based alloy according to the embodiment includes: a main phase that contains R₂Fe₁₄B as a main component; and an alloy grain boundary phase that has a higher R content than the main phase. The alloy grain boundary phase can be observed using a backscattered electron image of an electron microscope. The alloy grain boundary phase may contain only R or may contain R-T-M.

In the R-T-B-based alloy produced using the method of manufacturing an R-T-B-based alloy according to the embodiment, in order to adjust an interval between the alloy grain boundary phases to be 3 μm or less, it is necessary that the B content in the R-T-B-based alloy be 5.0 at % to 6.0 at %.

By adjusting the B content to be in the above-described range, the grain size of the alloy structure is refined to improve crushability, the grain boundary phase is uniformly distributed in the R-T-B-based magnet produced using the alloy, and superior coercive force is obtained. In order to obtain a fine alloy structure having superior crushability and an interval between the alloy grain boundary phases of 3 μm or less, the B content is preferably 5.5 at % or lower. However, when the B content in the R-T-B-based alloy is lower than 5.0 at %, an interval between adjacent alloy grain boundary phases of the R-T-B-based alloy is rapidly increased, and it is difficult to obtain a fine alloy structure having an interval between the alloy grain boundary phases of 3 μm or less. In addition, along with an increase in the B content in the R-T-B-based alloy, an interval between adjacent alloy grain boundary phases of the R-T-B-based alloy is increased, and alloy grains are coarsened. In addition, due to an excessive increase in the B content, a sintered magnet contains a B-rich phase. Therefore, when the B content exceeds 6.0 at %, the coercive force of an R-T-B-based magnet obtained using the R-T-B-based alloy may be insufficient.

In addition, in order to refine the grain size of the alloy structure to improve the coercive force of an R-T-B-based magnet obtained by using the alloy, the ratio (Fe/B) of the Fe content to the B content in the R-T-B-based molten alloy is preferably 13 to 15.5. In addition, when Fe/B is 13 to 15.5, the production of the transition metal-rich phase is not efficiently promoted during the production process of the R-T-B-based alloy and/or the production process of the R-T-B-based magnet. However, when Fe/B exceeds 15.5, an R₂T₁₇ phase is produced, which may decrease coercive force and squareness.

In addition, when Fe/B is lower than 13, the residual magnetization decreases.

In addition, in order to refine the grain size of the alloy structure to improve the coercive force of an R-T-B-based magnet obtained by using the alloy, B/TRE is preferably 0.32 to 0.40 and more preferably 0.34 to 0.38.

In addition, T contained in the R-T-B-based molten alloy is a transition metal essentially containing Fe. As a transition metal other than Fe contained in T of the R-T-B-based molten alloy, various elements in Groups 3 to 11, for example, Co, Zr, or Nb can be used. It is preferable that T of the R-T-B-based molten alloy further contains Co in addition to Fe because Tc (Curie temperature) can be improved. In addition, it is also preferable that T of the R-T-B-based molten alloy further contains Zr or Nb because the grain growth of the main phase can be limited during sintering.

As a result of a thorough study, the present inventors have found that, when B/TRE is in a range indicated by the following formula (1), the coercive force, residual magnetization, and squareness can be well-balanced at a high level.

0.32≦B/TRE≦0.40 (1)

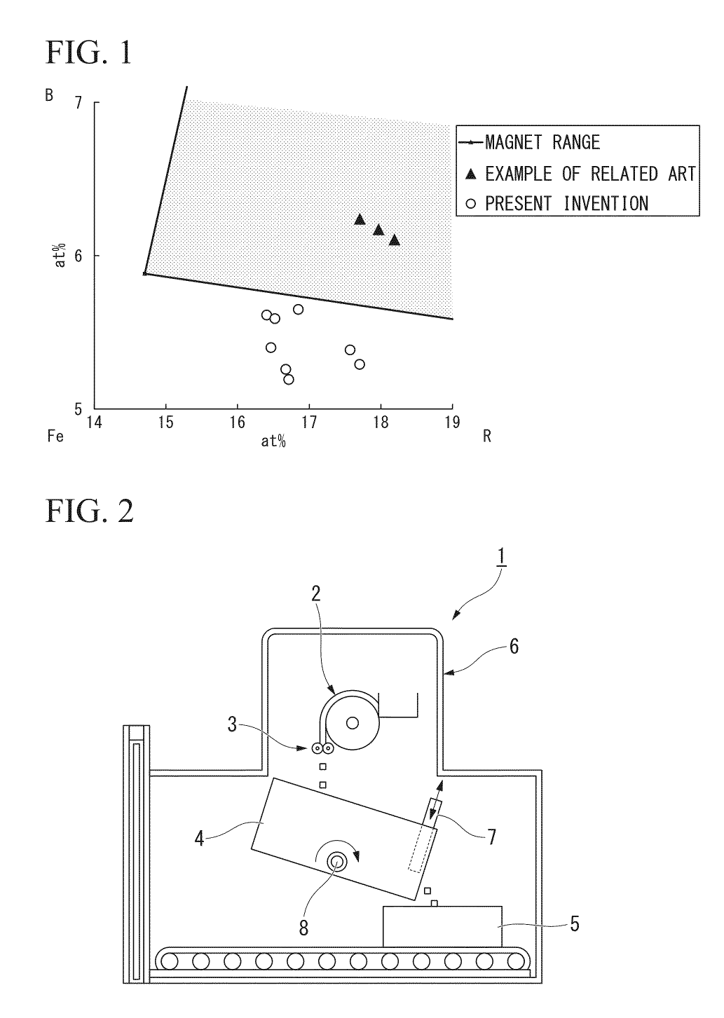

An alloy satisfying above formula (1) has a higher Fe concentration and a lower B concentration than an R-T-B-based alloy of the related art. FIG. 1 is an R-T-B ternary phase diagram. In FIG. 1, the vertical axis represents the B concentration, and the horizontal axis represents the Nd concentration. FIG. 1 shows that, the lower the B and Nd concentrations, the higher the Fe concentration. Typically, an alloy is cast so as to have a composition (for example, a composition shown by black symbol A (black) in FIG. 1) in a colored region (magnet range) to prepare an R-T-B-based magnet including a main phase and an R-rich phase. However, as shown by symbol O in FIG. 1, the composition of the R-T-B-based alloy satisfying the formula (1) is in a region deviated from the above-described region to the low B concentration side.

It is presumed that the metal element M contained in the R-T-B-based molten alloy according to the embodiment promotes the production of the transition metal-rich phase during a step of temporarily decreasing the cooling rate of a cast alloy strip (temperature holding step of a cast alloy described below) which is performed for manufacturing an R-T-B-based alloy, or during sintering and other heat treatment steps which are performed for manufacturing an R-T-B-based magnet. The metal element M contains at least one metal selected from the group consisting of Al, Ga, and Cu, and the R-T-B-based alloy contains the metal element M in a content of 0.1 at % to 2.4 at %.

The R-T-B-based molten alloy according to the embodiment contains the metal element M in an amount of 0.1 at % to 2.4 at %. Therefore, by sintering the R-T-B-based molten alloy, the R-T-B-based magnet containing the R-rich phase and the transition metal-rich phase is obtained.

During the temperature holding step of a cast alloy or during the sintering and other heat treatment steps of the R-T-B-based magnet, at least one metal selected from the group consisting of Al, Ga, and Cu which is contained in the metal element M promotes the production of the transition metal-rich phase so as to efficiently improve coercive force (Hcj) without adversely affecting other magnetic properties.

When the amount of the metal element M is lower than 0.1 at %, the effect of promoting the production of the transition metal-rich phase is insufficient, and thus the transition metal-rich phase is not formed in the R-T-B-based magnet. As a result, the coercive force (Hcj) of the R-T-B-based magnet may not be sufficiently improved. In addition, when the amount of the metal element M exceeds 2.4 at %, the magnetic properties of the R-T-B-based magnet such as magnetization (Br) and maximum energy product (BHmax) are decreased. The amount of the metal element M is more preferably 0.7 at % or higher and 1.4 at % or lower.

When the R-T-B-based alloy contains Cu, the Cu concentration is preferably 0.07 at % to 1 at %. When the Cu concentration is lower than 0.07 at %, the magnet is difficult to sinter. In addition, it is not preferable that the Cu concentration exceeds 1 at % because the magnetization (Br) of the R-T-B-based magnet decreases.

The R-T-B-based molten alloy according to the embodiment may further include Si in addition to R that is a rare earth element, T that is a transition metal essentially containing Fe, a metal element M that contains at least one metal selected from the group consisting of Al, Ga, and Cu, and B When the R-T-B-based molten alloy contains Si, the Si content is preferably in a range of 0.7 at % to 1.5 at %. When the Si content is in the above-described range, the coercive force is further improved. When the Si content is lower than 0.7 at % or exceeds 1.5 at %, an effect obtained by containing Si decreases.

In addition, when the total content of oxygen, nitrogen, and carbon in the R-T-B-based alloy is high, during a step of sintering an R-T-B-based magnet described below, the above elements and the rare earth element R are bonded to each other and the rare earth element R is consumed. Therefore, during the heat treatment after sintering the R-T-B-based alloy to obtain the R-T-B-based magnet, the amount of the rare earth element R used as the material of the transition metal-rich phase is decreased with respect to the total amount of the rare earth element R contained in the R-T-B-based alloy. As a result, the production amount of the transition metal-rich phase decreases, and thus the coercive force of the R-T-B-based magnet may be insufficient. Accordingly, in the embodiment, the total concentration of oxygen, nitrogen, and carbon in the R-T-B-based alloy is preferably 2 at % or lower. By adjusting the total concentration to be 2 at % or lower, the consumption of the rare earth element R is limited, and the coercive force (Hcj) can be efficiently improved.

### [Method of Manufacturing R-T-B-Based Alloy]

In a method of manufacturing an R-T-B-based alloy according to an embodiment of the present invention, first, for example, a molten alloy having a predetermined composition at a temperature of about 1450° C. is cast using, for example, a SC (strip cast) method to produce a cast alloy. Next, this cast alloy is crushed to obtain a cast alloy strip. A treatment (temperature holding step) of temporarily decreasing the cooling rate of the cast alloy strip at 700° C. to 900° C. to promote the diffusion of the elements in the alloy may be performed.

Next, the obtained cast alloy strip is decrepitated using a hydrogen decrepitation method or the like and is crushed using a crusher to obtain an R-T-B-based alloy. Hereinafter, each step will be described in detail.

### (Casting Step)

In the embodiment, the molten alloy is cast to produce a cast alloy. Typically, this cast alloy is crushed to obtain a cast alloy strip.

As an example of the casting step, a method of manufacturing a cast alloy using a production apparatus shown in FIG. 2 will be described.

(Apparatus configured to produce Cast alloy)

FIG. 2 is a schematic front view showing an example of an apparatus configured to produce a cast alloy which is capable of casting a cast alloy and then manufacturing a cast alloy strip.

Roughly, the apparatus 1 of manufacturing a cast alloy shown in FIG. 2 includes: a casting device 2 that casts a molten alloy; a crushing device 3 that crushes the cast alloy after the casting; an insulating container 4 that holds the temperature of the cast alloy strip after the crushing; and an absorbing container 5 that absorbs the cast alloy strip after the temperature-holding.

The production apparatus 1 shown in FIG. 2 includes a chamber 6. The internal atmosphere of the chamber 6 is an inert gas atmosphere under reduced pressure, and as the inert gas, for example, argon is used.

In the embodiment, in order to produce the cast alloy strip, first, a molten alloy having a predetermined composition at a temperature of about 1450° C. is prepared by using a melting device (not shown). Next, the obtained molten alloy is supplied to a cooling roll by using a tundish (not shown) and is solidified to obtain a cast alloy, the cooling roll being configured by a water-cooled copper roll of the casting device 2. Next, the cast alloy is separated from the cooling roll and is crushed by causing it to pass through a gap between crushing rolls of the crushing device 3, thereby obtaining a cast alloy strip. The cast alloy strip accumulates in the insulating container 4 which is disposed below the crushing device 3.

Next, a gate plate 7 is opened, and the insulating container 4 is tilted along a rotary shaft 8 so as to send the cast alloy strip into the absorbing container 5.

In the embodiment, while the cast alloy having a temperature of higher than 800° C. is cooled to a temperature of lower than 500° C., a temperature holding step of holding a certain temperature for 10 seconds to 120 seconds may be performed.

It is presumed that, when the temperature holding step is performed, the elements contained in the cast alloy strip are rearranged to move into the cast alloy strip, and thus component exchange between the metal element M, which contains at least one metal selected from the group consisting of Al, Ga, and Cu, and B is promoted. Therefore, it is presumed that a portion of B contained in a region forming the alloy grain boundary phase moves to the main phase, and a portion of the metal element M contained in a region forming the main phase moves to the alloy grain boundary phase. As a result, it is presumed that intrinsic magnetic properties of the main phase can be exhibited, and thus the coercive force of an R-T-B-based magnet obtained using the cast alloy is improved.

When the temperature of the cast alloy strip in the temperature holding step exceeds 800° C., the alloy structure may be coarsened. In addition, when the certain temperature holding time exceeds 120 seconds, there may be an adverse effect on productivity.

In addition, when the temperature of the cast alloy strip is lower than 500° C. or the certain temperature holding time is shorter than 10 seconds in the temperature holding step, the element rearrangement effect obtained by performing the temperature holding step may be insufficient.

In the embodiment, the case where the R-T-B-based alloy is manufactured by using the SC method has been described. However, the R-T-B-based alloy used in the present invention is not limited to the configuration of being manufactured by using the SC method. For example, the R-T-B-based alloy may be cast using a centrifugal casting method, a book mold casting method, or the like.

### (Hydrogen Decrepitation Step)

The hydrogen decrepitation step of the method of manufacturing an alloy for an R-T-B-based rare earth sintered magnet according to the present invention includes a hydrogenating step and a dehydrogenating step.

The cast alloy or the cast alloy strip absorbing hydrogen in the hydrogen decrepitation method expands in volume. Therefore, a large number of cracks are formed in the alloy, and thus the alloy is decrepitated.

In the hydrogenating step, the cast alloy or the cast alloy strip manufactured in the casting step absorbs hydrogen. The hydrogenating step can be performed using a well-known method under well-known conditions.

For example, the alloy is held in a hydrogen gas atmosphere under a pressure of 0.1 MPa to 0.105 MPa at a temperature of room temperature to 100° C. until a decrease in hydrogen gas pressure is lower than 1 kPa per minute.

In the dehydrogenating step, hydrogen is removed from the cast alloy or the cast alloy strip absorbing hydrogen.

The dehydrogenating step according to the present invention may be performed in an inert gas atmosphere at a temperature lower than 550° C. or may be performed in a vacuum at a temperature lower than 600° C.

The reason is as follows. In an R-T-B-based rare earth sintered magnet manufactured by using the alloy which undergoes the dehydrogenating step in an inert gas atmosphere at 550° C. or higher, sufficient squareness and coercive force cannot be obtained. In addition, in an R-T-B-based rare earth sintered magnet manufactured by using the alloy which undergoes the dehydrogenating step in a vacuum at 600° C. or higher, sufficient coercive force cannot be obtained.

It is preferable that the dehydrogenating step is performed in a temperature range of 300° C. to 500° C. In this temperature range, sufficient coercive force and squareness can be obtained in an R-T-B-based rare earth sintered magnet manufactured by using the alloy regardless of whether the dehydrogenating step is performed in an inert gas atmosphere or in a vacuum.

As the inert gas, for example, argon is used.

### (Fine Crushing Step)

For example, a jet mill is used to crush the cast alloy strip which undergoes hydrogen decrepitation. The cast alloy strip which undergoes hydrogen decrepitation is put into a jet mill crusher and is finely crushed into powder having an average particle size of 1.4 μm to 5 μm using 0.6 MPa of high-pressure nitrogen. When the average particle size of the powder is small, the coercive force of the sintered magnet can be improved. However, when the average particle size is excessively small, the particle surface is likely to be oxidized, and conversely, the coercive force is decreased.

### [Method of Manufacturing R-T-B-Based Rare Earth Sintered Magnet]

Next, a method of manufacturing an R-T-B-based magnet by using the R-T-B-based alloy, which is manufactured by using the method of manufacturing an alloy for an R-T-B-based rare earth sintered magnet according to the embodiment, will be described.

For example, a method of adding 0.02 mass % to 0.03 mass % of zinc stearate as a lubricant to the powder of the R-T-B-based alloy according to the embodiment, press-molding the mixture using a molding machine in a transverse field, sintering the molded product in a vacuum, and performing a heat treatment thereon is used.

When the heat treatment is performed at 400° C. to 800° C. after sintering at 800° C. to 1200° C. and more preferably 900° C. to 1200° C., the transition metal-rich phase is more likely to be manufactured in the R-T-B-based magnet, and the coercive force of the R-T-B-based magnet is further improved.

According to the above-described method of manufacturing an R-T-B-based magnet, the R-T-B-based alloy which has a B content satisfying the above-described formula (1) and contains 0.1 at % to 2.4 at % of the metal element M is used. Therefore, an R-T-B-based magnet is obtained, the R-T-B-based magnet including: a main phase that contains R₂Fe₁₄B as a main component; and a grain boundary phase that has a higher R content than the main phase, in which the grain boundary phase includes an R-rich phase having a total atomic concentration of the rare earth element of 70 at % or higher and a transition metal-rich phase having a total atomic concentration of the rare earth element of 25 at % to 35 at %.

Further, in the R-T-B-based alloy manufactured by using the method of manufacturing an R-T-B-based alloy according to the embodiment, by adjusting the kind and amount of the metal element contained therein and the composition of the R-T-B-based alloy and adjusting the sintering temperature and conditions of the heat treatment and the like after sintering, the volume ratio of the transition metal-rich phase in the R-T-B-based magnet can be easily adjusted to be in a preferable range of 0.005 vol % to 3 vol %.

By adjusting the volume ratio of the transition metal-rich phase in the R-T-B-based magnet, the R-T-B-based magnet having a predetermined coercive force according to the intended use can be obtained while limiting the Dy content.

In addition, it is presumed that the effect of improving the coercive force (Hcj) obtained in the R-T-B-based magnet is derived from the formation of the transition metal-rich phase containing a high concentration of Fe in the grain boundary phase. The volume ratio of the transition metal-rich phase contained in the R-T-B-based magnet is preferably 0.005 vol % to 3 vol % and more preferably 0.1 vol % to 2 vol %. When the volume ratio of the transition metal-rich phase is in the above-described range, the coercive force improvement effect obtained by the grain boundary phase containing the transition metal-rich phase is more efficiently obtained. On the other hand, when the volume ratio of the transition metal-rich phase is lower than 0.1 vol %, the effect of improving the coercive force (Hcj) may be insufficient. In addition, it is not preferable that the volume ratio of the transition metal-rich phase exceeds 3 vol % because there is an adverse effect on magnetic properties, for example, a decrease in residual magnetization (Br) and maximum energy product ((BH)max).

The Fe atomic concentration in the transition metal-rich phase is preferably 50 at % to 70 at %. When the Fe atomic concentration in the transition metal-rich phase is in the above-described range, the effect obtained by the grain boundary phase containing the transition metal-rich phase is more efficiently obtained. On the other hand, when the Fe atomic concentration in the transition metal-rich phase is lower than the above-described range, the coercive force (Hcj) improvement effect obtained by the grain boundary phase containing the transition metal-rich phase may be insufficient. In addition, when the Fe atomic concentration in the transition metal-rich phase exceeds the above-described range, an R₂T₁₇ phase or Fe is precipitated, which may adversely affect magnetic properties.

The volume ratio of the transition metal-rich phase in the R-T-B-based magnet is examined using the following method. First, the R-T-B-based magnet is embedded into a conductive resin, and a surface thereof parallel to an orientation direction is cut out to be mirror-polished. Next, a backscattered electron image of the mirror-polished surface is observed at a magnification of about 1500 times, and the main phase, the R-rich phase, and transition metal-rich phase are determined through the contrast. Next, the area ratio of the transition metal-rich phase per cross-section is calculated, and a volume ratio thereof is also calculated under the assumption that the cross-section is spherical.

The R-T-B-based magnet is obtained by molding and sintering an R-T-B-based alloy, which has a B/TRE content satisfying the above-described the formula (1) and contains 0.1 at % to 2.4 at % of the metal element M. In the R-T-B-based alloy, the grain boundary phase contains an R-rich phase and a transition metal-rich phase, and the transition metal-rich phase has a lower total atomic concentration of the rare earth element and a higher Fe atomic concentration than the R-rich phase. Therefore, while limiting the Dy content, high coercive force is obtained, and superior magnetic properties suitable for a motor are obtained.

The higher the coercive force (Hcj) of the R-T-B-based magnet is, the better it is as a magnet. However, when the R-T-B-based magnet is used as a magnet for an electric power steering motor of an automobile or the like, the coercive force is preferably 20 kOe or higher. In addition, when the R-T-B-based magnet is used as a magnet for an electric vehicle motor, the coercive force is preferably 30 kOe or higher. When the coercive force (Hcj) is lower than 30 kOe in a magnet for an electric vehicle motor, heat resistance as a motor may be insufficient.

### Examples

### Examples 1 to 11 and Comparative Examples 1 to 8

Nd metal (purity: 99 wt % or higher), Pr metal (purity: 99 wt % or higher), Dy metal (purity: 99 wt % or higher), ferroboron (Fe: 80%, B: 20%), iron ingot (purity: 99 wt % or higher), Al metal (purity: 99 wt % or higher), Ga metal (purity: 99 wt % or higher), Cu metal (purity: 99 wt % or higher), Co metal (purity: 99 wt % or higher), and Zr metal (purity: 99 wt % or higher) were weighed so as to obtain alloy compositions of Alloys A to E shown in Table 1 and were placed in an alumina crucible.

TABLE 1

(at %)

| | Alloy A | Alloy B | Alloy C | Alloy D | Alloy E |
|---|---|---|---|---|---|
| TRE | 15.3 | 14.6 | 14.5 | 15.2 | 13.3 |
| Nd | 11.3 | 10.7 | 10.0 | 8.5 | 13.3 |
| Pr | 4.0 | 3.8 | 3.6 | 3.0 | 0.0 |
| Dy | 0.0 | 0.0 | 0.9 | 3.7 | 0.0 |
| Al | 0.4 | 0.5 | 0.4 | 0.4 | 0.8 |
| Fe | 76.3 | 76.3 | 76.9 | 76.5 | 78.7 |
| Ga | 0.5 | 0.5 | 0.5 | 0.5 | 0.0 |
| Cu | 0.1 | 0.1 | 0.1 | 0.1 | 0.0 |
| Co | 1.0 | 1.0 | 1.0 | 1.0 | 0.0 |
| Zr | 0.0 | 0.1 | 0.1 | 0.0 | 0.0 |
| B | 5.1 | 5.5 | 5.4 | 5.2 | 5.9 |
| C | 0.4 | 0.4 | 0.1 | 0.1 | 0.4 |
| O | 0.6 | 0.7 | 0.6 | 0.6 | 0.6 |
| N | 0.2 | 0.2 | 0.2 | 0.2 | 0.2 |
| B/TRE | 0.34 | 0.38 | 0.37 | 0.34 | 0.44 |
| Fe/B | 14.9 | 13.9 | 14.1 | 14.7 | 13.3 |

Next, the alumina crucible was provided in a high-frequency vacuum induction furnace, and the furnace atmosphere was substituted with Ar. The high-frequency vacuum induction furnace was heated to 1450° C. to melt the metals, and then the molten alloy was poured into a water-cooled copper roll and was cast into a cast alloy by using a SC (strip cast) method. At this time, the peripheral speed of the water-cooled copper roll was adjusted to 1.0 msec, and the average thickness of the molten alloy was adjusted to about 0.3 mm. Next, the cast alloy was crushed to obtain a cast alloy strip.

Next, the following hydrogen decrepitation step was performed on the cast alloy strip to decrepitate the cast alloy strip.

Specifically, first, the cast alloy strip was coarsely crushed into a diameter of about 5 mm and was put into a hydrogen atmosphere to absorb hydrogen. Next, the cast alloy strip absorbing hydrogen underwent a heat treatment of heating the strip to 300° C. in a hydrogen atmosphere. Next the cast alloy strip was held in an atmosphere at a temperature shown in Table 2 for 1 hour to perform the dehydrogenating step.

Next, 0.025 wt % of zinc stearate as a lubricant was added to the cast alloy strip which underwent hydrogen decrepitation. Using a jet mill (100 AFG, manufactured by Hosokawa Micron Corporation), the cast alloy strip which underwent hydrogen decrepitation was finely crushed into an average particle size (d50) of 4.5 μm with 0.6 MPa of high-pressure nitrogen. As a result, an R-T-B-based alloy (powder) was obtained.

Next, the R-T-B-based alloy powder obtained as explained above was press-molded into a green compact under a molding pressure of 0.8 t/cm² by using a molding machine in a transverse field. Next, the obtained green compact was sintered in a vacuum at a temperature of 900° C. to 1200° C. Next, the sintered compact was heat-treated in two steps at temperatures of 800° C. and 500° C. and then was cooled. As a result, R-T-B-based magnets of Examples 1 to 11 were prepared.

In addition, sintered magnets of Comparative Examples 1 to 6 were prepared by the same procedure as that of Example 1, except for the conditions of the dehydrogenating step. In addition, a sintered magnet of Comparative Example 7 was prepared by the same procedure as that of Example 1, except that the dehydrogenating step was not performed in the hydrogen decrepitation step. A sintered magnet of Comparative Example 8 was prepared by the same procedure as that of Example 1, except that the hydrogen decrepitation step was not performed.

The magnetic properties of the obtained R-T-B-based magnets of Examples 1 to 11 and the sintered magnets of Comparative Examples 1 to 8 were measured by using a BH curve tracer (TPM2-10, manufactured by Toei Industry Co., Ltd.). The results are shown in Table 2.

TABLE 2

| | | | Temperature of | | | | | |
|---|---|---|---|---|---|---|---|---|
| | | Atmosphere of | Dehydrogenating | Br | Hcj | (BH)max | | |
| | | Dehydrogenating Step | Step (° C.) | (kG) | (kOe) | (MGOe) | Hk90/Hcj | Note |
| Example 1 | Alloy A | Argon | 300 | 13.2 | 20.0 | 42.1 | 0.915 | |
| Example 2 | Alloy A | Argon | 400 | 13.4 | 19.5 | 43.7 | 0.907 | |
| Example 3 | Alloy A | Argon | 500 | 13.4 | 20.1 | 43.4 | 0.900 | |
| Example 4 | Alloy A | Vacuum | 400 | 13.3 | 19.6 | 43.4 | 0.906 | |
| Example 5 | Alloy A | Vacuum | 500 | 13.4 | 19.7 | 43.7 | 0.907 | |
| Example 6 | Alloy B | Argon | 500 | 13.9 | 17.4 | 47.2 | 0.906 | |
| Example 7 | Alloy B | Vacuum | 500 | 13.9 | 17.6 | 46.8 | 0.913 | |
| Example 8 | Alloy C | Argon | 500 | 13.4 | 22.3 | 43.3 | 0.918 | |
| Example 9 | Alloy C | Vacuum | 500 | 13.3 | 22.4 | 42.9 | 0.925 | |
| Example 10 | Alloy D | Argon | 500 | 11.5 | 36.2 | 32.5 | 0.878 | |
| Example 11 | Alloy D | Vacuum | 500 | 11.4 | 37.3 | 32.2 | 0.885 | |
| Comparative | Alloy A | Argon | 550 | 13.3 | 19.6 | 42.8 | 0.826 | |
| Example 1 | | | | | | | | |
| Comparative | Alloy A | Argon | 600 | 13.2 | 7.8 | 36.2 | 0.661 | |
| Example 2 | | | | | | | | |
| Comparative | Alloy A | Vacuum | 600 | 13.3 | 19.6 | 43.5 | 0.840 | |
| Example 3 | | | | | | | | |
| Comparative | Alloy E | Vacuum | 500 | 12.8 | 13.7 | 38.3 | 0.935 | |
| Example 4 | | | | | | | | |
| Comparative | Alloy E | Argon | 500 | 12.9 | 13.6 | 38.5 | 0.930 | |
| Example 5 | | | | | | | | |
| Comparative | Alloy E | Argon | 600 | 12.9 | 13.8 | 38.7 | 0.940 | |
| Example 6 | | | | | | | | |
| Comparative | Alloy E | None | | 10.2 | 10.5 | 16.0 | 0.598 | Only Hydrogen |
| Example 7 | | | | | | | | Absorbing Step |
| | | | | | | | | Performed |
| Comparative | Alloy E | None | | 11.8 | 10.8 | 31.1 | 0.886 | Hydrogen Decrepitation |
| Example 8 | | | | | | | | Not Performed |

In Table 2, “Hcj” represents the coercive force, “Br” represents the residual magnetization, “(BH)max” represents the maximum energy product, and “Hk90/Hcj” represents the squareness. In addition, these values of the magnetic properties are the average of the measured values of five R-T-B-based magnets for each example.

In Examples 1 to 3, the dehydrogenating steps in argon atmosphere at temperature of 300° C., 400° C., and 500° C., respectively, were performed by using an R-T-B-based alloy having a composition of Alloy A in which the Dy concentration is 0.0 at %.

In Examples 4 and 5, the dehydrogenating steps in a vacuum at temperature of 400° C. and 500° C., respectively, were performed by using R-T-B-based alloy having a composition of Alloy A in which the Dy concentration is 0.0 at %.

In all the Examples 1 to 5, the values of coercive force and squareness were superior.

On the other hand, in Comparative Examples 1 and 2, the dehydrogenating steps in argon atmosphere at temperature of 550° C. and 600° C., respectively, were performed by using R-T-B-based alloy having a composition of Alloy A.

In Comparative Example 3, the dehydrogenating step in a vacuum at temperature of 600° C. was performed by using R-T-B-based alloy having a composition of Alloy A.

In Comparative Example 1, the coercive force was equal to those of Examples 1 to 5, and the squareness was significantly lower than those of Examples 1 to 5.

In Comparative Example 2, both coercive force and squareness were significantly low.

In Comparative Example 3, the coercive force was equal to those of Examples 1 to 5, and the squareness was significantly lower than those of Examples 1 to 5.

In Example 6, the dehydrogenating step in argon atmosphere at temperature of 500° C. was performed by using R-T-B-based alloy having a composition of Alloy B in which the Dy concentration is 0.0 at %.

In Example 7, the dehydrogenating step in a vacuum at temperature of 500° C. was performed by using R-T-B-based alloy having a composition of the Alloy B.

In Examples 6 and 7, the coercive force was lower and the squareness was equal to or higher than those of Examples 1 to 5, and overall characteristics were superior. The reason why the coercive force was low was presumed to be due to the value of B/TRE.

In Example 8, the dehydrogenating step in argon atmosphere at temperature of 500° C. was performed by using R-T-B-based alloy having a composition of Alloy C in which the Dy concentration is 0.9 at %.

In Example 9, the dehydrogenating step in a vacuum at temperature of 500° C. was performed by using R-T-B-based alloy having a composition of the Alloy C.

In Examples 8 and 9, the coercive force and the squareness were higher than those of Examples 1 to 5.

In Example 10, the dehydrogenating step in argon atmosphere at temperature of 500° C. was performed by using R-T-B-based alloy having a composition of Alloy D in which the Dy concentration is 3.7 at %.

In Example 11, the dehydrogenating step in a vacuum at temperature of 500° C. was performed by using R-T-B-based alloy having a composition of the Alloy D.

In Examples 10 and 11, the coercive force was far superior to those of Examples 8 and 9, but the squareness was lower than those of Examples 1 to 5.

In Comparative Examples 4 and 5, an R-T-B-based alloy having a composition of Alloy E in which the formula (1) was not satisfied underwent the dehydrogenating step in a vacuum at a temperature of 500° C., or underwent the dehydrogenating step in an argon atmosphere at a temperature of 500° C.

In Comparative Example 4, the dehydrogenating step in a vacuum at temperature of 500° C. was performed by using R-T-B-based alloy having a composition of Alloy E which does not satisfy the formula (1).

In Comparative Example 5, the dehydrogenating step in argon atmosphere at temperature of 500° C. was performed by using R-T-B-based alloy having a composition of the Alloy E.

In Comparative Examples 4 and 5, the dehydrogenating step was performed under conditions where superior coercive force was obtained in the R-T-B-based alloys of Alloys A to D. However, even in this case, sufficient coercive force was not obtained.

In Comparative Example 6, an R-T-B-based alloy having a composition of Alloy E in which the formula (1) was not satisfied underwent the dehydrogenating step in an argon atmosphere at a temperature of 600° C.

In Comparative Example 6, the dehydrogenating step in argon atmosphere at temperature of 600° C. was performed by using R-T-B-based alloy having a composition of Alloy E which does not satisfy the formula (1).

Even in this case, sufficient coercive force was not obtained.

However, in the case of the R-T-B-based alloy having a composition of Alloy E which did not satisfy the formula (1), there were no significant differences in coercive force and squareness between the case (Comparative Example 5) where the dehydrogenating step was performed in an argon atmosphere at a temperature of 500° C. and the case (Comparative Example 6) where the dehydrogenating step was performed in an argon atmosphere at a temperature of 600° C.

This point is different from the case of the R-T-B-based alloy having a composition of Alloy A which satisfied the formula (1). In the case of the R-T-B-based alloy having a composition of Alloy A, there were significant differences in coercive force and squareness between the case (Example 3) where the dehydrogenating step was performed in an argon atmosphere at a temperature of 500° C. and the case (Comparative Example 2) where the dehydrogenating step was performed in an argon atmosphere at a temperature of 600° C. In addition, in the case of the R-T-B-based alloy having a composition of Alloy A in which the formula (1) was satisfied, there was substantially no difference in coercive force but there was a difference in squareness between the case (Comparative Example 5) where the dehydrogenating step was performed in a vacuum at a temperature of 500° C. and the case (Comparative Example 3) where the dehydrogenating step was performed in a vacuum at a temperature of 600° C. In this way, the reason why there are significant differences in characteristics between the R-T-B-based alloys having a composition developed by the present inventors in which the formula (1) was satisfied and the R-T-B-based alloys of the related art in which the formula (1) was not satisfied is presumed to be as follows: the R-T-B-based alloys having a composition developed by the present inventors have a configuration which is completely different from that of the R-T-B-based alloys of the related art. That is, the conditions of the dehydrogenating step discovered by the present inventors are unique to the R-T-B-based alloy having a low B concentration developed by the present inventors.

In Comparative Example 7, only the hydrogenating step was performed without performing the dehydrogenating step. In Comparative Example 7, only the hydrogen decrepitating step was not performed.

In these cases, the coercive force was far lower and the squareness was lower than those of Comparative Examples 4 to 6.

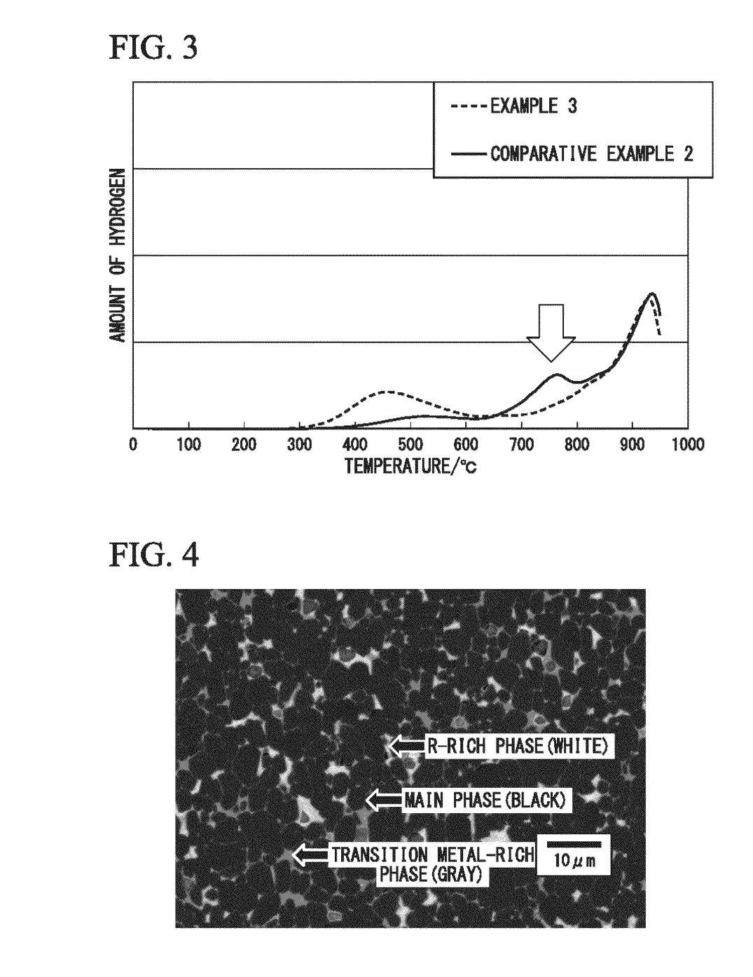

FIG. 3 is a graph showing the results of examining the amounts of dehydrogenating from alloys of Example 3 and Comparative Example 2 when being heated in order to determine factors affecting squareness. That is, when the alloys used in Example 3 and Comparative Example 2 underwent the hydrogen decrepitation step, the temperature dependence of the amounts of dehydrogenating from the alloys was examined.

In Example 3, the reason why the amount of dehydrogenated was increased at 400° C. to 500° C. was presumed to be that the valence of a hydride was changed from trivalence to divalence. Next, the reason why the amount of dehydrogenated was increased at a temperature close to the sintering temperature was presumed to be that, as in the case of the production of a typical sintered magnet, hydrogen was produced during the decomposition of a hydride into metal.

On the other hand, in Comparative Example 2, a peak of the amount of dehydrogenated was shown at 700° C. to 800° C. before the sintering temperature. The peak was not shown in Example 3, and it is presumed that this peak implies the presence of a hydride different from that of Example 3. The presence of the hydride may be one of the factors decreasing squareness.

FIG. 4 is a backscattered electron image showing the R-T-B-based magnet of Example 3. In the backscattered electron image, an R₂T₁₄B phase (black portions) as a main phase, an R-rich phase (white portions), and a transition metal-rich phase (gray portions) are shown.

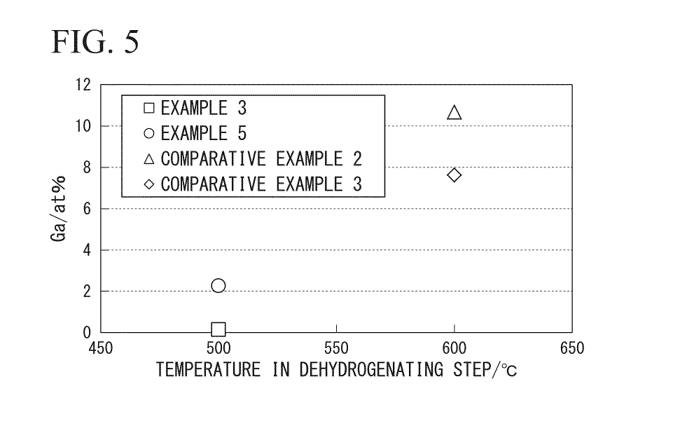

FIG. 5 is a graph showing the results of examining the Ga concentrations of R-rich phases of Examples 3 and 5 and Comparative Examples 2 and 3. In FIG. 5, the horizontal axis represents the temperature of the dehydrogenating step, and the vertical axis represents the Ga concentration (at %).

In Comparative Examples 2 and 3, regardless of whether the dehydrogenating step was performed in an argon atmosphere or in a vacuum, the Ga concentration in the R-rich phase at a temperature of the dehydrogenating step of 600° C. was higher than those of Examples 3 and 5. This result shows that Ga in the R-rich phase may be one of the factors decreasing squareness.

While preferred embodiments of the invention have been described and shown above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

2: CASTING DEVICE
5: ABSORBING CONTAINER
10: PRODUCTION APPARATUS
21: CRUSHING DEVICE
52: INSULATING CONTAINER
53: GATE PLATE
55: ROTARY SHAFT

What is claimed is:

1. A method of manufacturing an alloy for an R-T-B-based rare earth sintered magnet, comprising:
a casting step of manufacturing a cast alloy by casting a molten alloy,
a hydrogenating step of absorbing hydrogen in the cast alloy; and
a dehydrogenating step of removing hydrogen from the cast alloy that absorbs hydrogen in an inert gas atmosphere at a temperature lower than 550° C.,
wherein the molten alloy comprises B; a rare earth element R; a transition metal T comprising Fe; a metal element M that comprises at least one metal selected from the group consisting of Al, Ga, and Cu; and unavoidable impurities,
the R content is 13 at % to 15.5 at %,
the B content is 5.0 at % to 6.0 at %,
the M content is 0.1 at % to 2.4 at %,
the T content is a balance,
a ratio of a Dy content to a total content of the rare earth element is 0 at % to 65 at %, and
the molten alloy satisfies the below formula (1):
0.32≦B/TRE≦0.40 (1)
wherein B represents a boron concentration (at %), and TRE represents a total concentration (at %) of all the rare earth elements in the formula (1).

2. A method of manufacturing an alloy for an R-T-B-based rare earth sintered magnet, comprising:
a casting step of manufacturing a cast alloy by casting a molten alloy,
a hydrogenating step of absorbing hydrogen in the cast alloy; and
a dehydrogenating step of removing hydrogen from the cast alloy that absorbs hydrogen in a vacuum at a temperature lower than 600° C.,
wherein the molten alloy comprises B; a rare earth element R; a transition metal T comprises Fe; a metal element M that comprises at least one metal selected from the group consisting of Al, Ga, and Cu; and unavoidable impurities,
the R content is 13 at % to 15.5 at %,
the B content is 5.0 at % to 6.0 at %,
the M content is 0.1 at % to 2.4 at %,
the T content is a balance,
a ratio of a Dy content to a total amount of the rare earth element is 0 at % to 65 at %, and
the molten alloy satisfies the below formula (1):
0.32≦B/TRE≦0.40 (1)
wherein B represents a boron concentration (at %), and TRE represents a total concentration (at %) of all the rare earth elements in the formula (1).

3. The method of manufacturing an alloy for an R-T-B-based rare earth sintered magnet according to claim 1,
wherein the dehydrogenating step is performed at 300° C. to 500° C.

4. The method of manufacturing an alloy for an R-T-B-based rare earth sintered magnet according to claim 2,
wherein the dehydrogenating step is performed at 300° C. to 500° C.

5. A method of manufacturing an R-T-B-based rare earth sintered magnet,
wherein an alloy for an R-T-B-based rare earth sintered magnet, which is manufactured by using the method of manufacturing an alloy for an R-T-B-based rare earth sintered magnet according to claim 1, is used.

6. A method of manufacturing an R-T-B-based rare earth sintered magnet,
wherein an alloy for an R-T-B-based rare earth sintered magnet, which is manufactured by using the method of manufacturing an alloy for an R-T-B-based rare earth sintered magnet according to claim 2, is used.

7. A method of manufacturing an R-T-B-based rare earth sintered magnet,
wherein an alloy for an R-T-B-based rare earth sintered magnet, which is manufactured by using the method of manufacturing an alloy for an R-T-B-based rare earth sintered magnet according to claim 3, is used.

8. A method of manufacturing an R-T-B-based rare earth sintered magnet,
wherein an alloy for an R-T-B-based rare earth sintered magnet, which is manufactured by using the method of manufacturing an alloy for an R-T-B-based rare earth sintered magnet according to claim 4, is used.

9. A method of manufacturing an R-T-B-based rare earth sintered magnet, comprising steps of
manufacturing an alloy for an R-T-B-based rare earth sintered magnet by using the method according to claim 1, and
manufacturing an R-T-B-based rare earth sintered magnet by using the obtained alloy for an R-T-B-based rare earth sintered magnet.

10. A method of manufacturing an R-T-B-based rare earth sintered magnet, comprising steps of
manufacturing an alloy for an R-T-B-based rare earth sintered magnet by using the method according to claim 2, and
manufacturing an R-T-B-based rare earth sintered magnet by using the obtained alloy for an R-T-B-based rare earth sintered magnet.

11. The method of manufacturing an R-T-B-based rare earth sintered magnet according to claim 9,
wherein in the step of manufacturing an alloy for an R-T-B-based rare earth sintered magnet, the dehydrogenating step is performed at 300° C. to 500° C.

12. The method of manufacturing an R-T-B-based rare earth sintered magnet according to claim 10,
wherein in the step of manufacturing an alloy for an R-T-B-based rare earth sintered magnet, the dehydrogenating step is performed at 300° C. to 500° C.
